(19) United States
(12) Patent Application Publication
(10) Pub. No.: US 2004/0130554 A1
(43) Pub. Date: Jul. 8, 2004

(54) Application of visual effects to a region of interest within an image

(76) Inventor: Andrew Bangham, Cambridge (GB)

Correspondence Address: Boyle Fredrickson Newholm, Stein & Gratz, Suite 1030, 250 East Wisconsin Avenue, Milwaukee, WI, 53202-4232, US

(21) Appl. No.: 10/471,035

(22) PCT Filed: Mar. 7, 2002
(86) PCT No.: PCT/GB02/01084

(30) Foreign Application Priority Data
Mar. 7, 2001 (GB) 0105561.5

(51) Int. Cl. G09G 5/02

(52) U.S. Cl. 345/589

(57) ABSTRACT

A method of processing an image. The method comprises the step of selecting an initial mask and automatically comparing the initial mask with a selected characteristic of the image to generate defining a processing mask with the image. The image is the process within the processing mask to apply a visual effect to the image within the processing mask.

This invention relates to image signal processing and, in particular, to the processing of still or motion digital photographic images in order to automate the application of selected visual effects to those images.

A conventional artist starts with a blank canvas, adds paint and knows when to stop. By application of the arist's talent and experience he or she is able to control the progressive addition of detail, highlighting and shadows that characterises the process of producing representational art. Of course, many people who are interested in producing artistic representations of images do not have the level of skill or the experience necessary to produce high quality representational art images. However, in recent times there have been attempts, through digital image signal processing, to provide computerised tools which enable a lay person to manipulate still or video photographic images to produce effects that mimic the effects that can be generated by a skilled and experienced artist.

Computer software packages that provide the necessary tools to provide a number of different rendering and image manipulation functions have been known for many years. Such software has normally taken one of two approaches. One approach has been to provide tools for a user to use, with the tools generating certain effects, such as brush stroking and spray painting effects in order to simulate traditional artistic tools so that images can be created on a computer screen or a computer-controlled printer. The other approach, which is that to which the present invention generally relates, provides tools for manipulation of previously generated still or video photographic images which have been input into a computer for manipulation thereon. In this latter category tools have been provided which create effects on a chosen image such as watercolour effects, oil painting effects, as well as more general blurring and removal of detail effects. However, many, if not all, such software tools are constrained in that they are often quite difficult to use and require a considerable amount of skill for an end user can produce effects that come close in any way to the artistic quality of a skilled artist. Accordingly, there is a need for a system which automates many of the effects processes in order to reduce the complexity of operation of that system, yet which still provides an effect which is pleasing to the eye and suitable for the particular image being processed.

According to the present invention there is provided a method of processing an image, the method comprising the steps of:

selecting an initial mask;

automatically comparing the initial mask with a selected characteristic of the image to generate data defining a processing mask within the image; and

processing the image within the processing mask to apply a visual effect to the image within the processing mask.

The initial mask may have a simple geometric shape such as a square or circle. Alternatively, the initial mask may have a shape which is determined by analysis of the image with respect to a predefined characteristic. The predefined characteristic may be one or more of colour, luminance, colour boundary, luminance boundary or image detail level.

Alternatively, the shape of the initial mask may be generated by employment of statistical data analysis generated from previously input images.

In all cases the initial mask may be centred on the central region of the image.

When the mask is generated from the image data. It may be generated after the image has been processed by a simplification filter.

The image processing that is performed within the processing mask may include the addition of additional detail to the selected region, change in the contrast, a change in colouring, or a combination thereof.

The present invention also provides a computer configured to perform the above method and a computer readable medium storing instructions to perform the above method.

The present invention enables the automatic generation of images which can reproduce the effects generated by a skilled artist on an image of the users choosing. It does this by enabling the automatic selection of a region which is effectively the “focal region of interest” of the image and then enabling an additional level of detail in that area of the image. The area of interest may be the centre of the picture. Accordingly, in operation, the image is processed to select a region which corresponds specifically to the objects in the image and then enables, either through manual or automatic selection, the application of additional image qualities to the particular region of interest whilst allowing the remainder of the image to be processed perhaps to remove additional detail and/or introduce other painterly effects, such as removal of detail and color washing.

The present invention may employ a tree representation to automatically generate the focal region of interest. Nodes from the tree that represent the focal region of interest (the mask which is processed) are then selected by choosing the most likely (through statistical analysis) features to be a part of the focal region of interest. The likelihood can be established by reference to a previously obtained set of probabilities determined from a set of reference pictures or determined through user input.

Examples of the present invention will now be described with reference to the accompanying drawings, which:

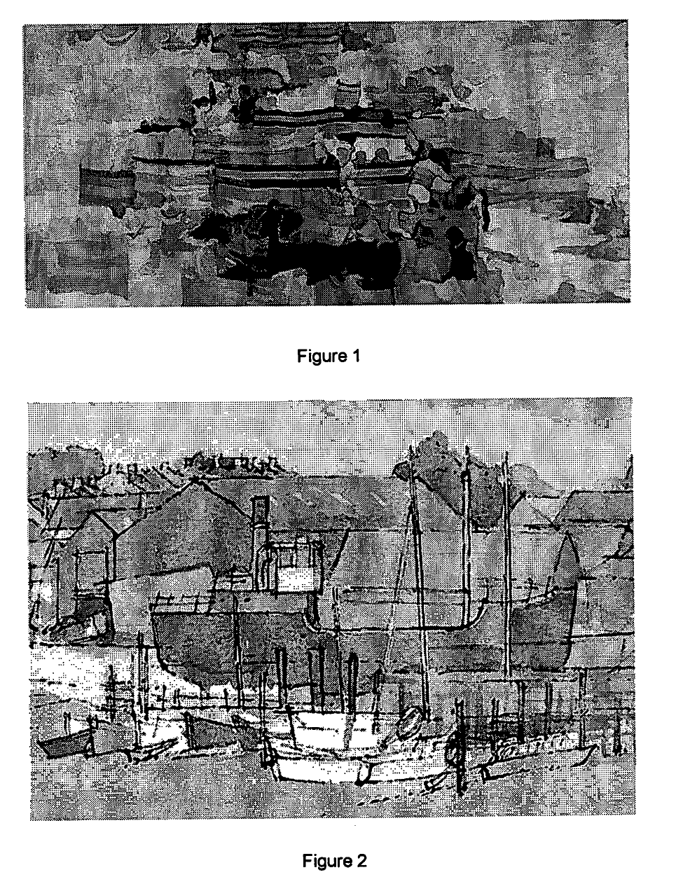

FIGS. 1 and 2 are example artistic representations of an image showing differing styles of representations;

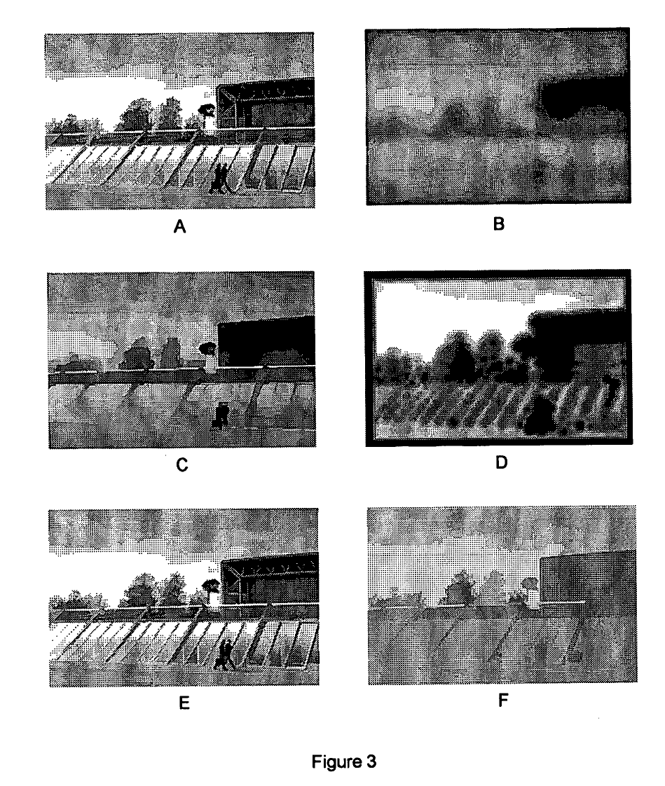

FIGS. 3A to 3F show example outputs of differing image signal processing algorithms applied to a single reference image;

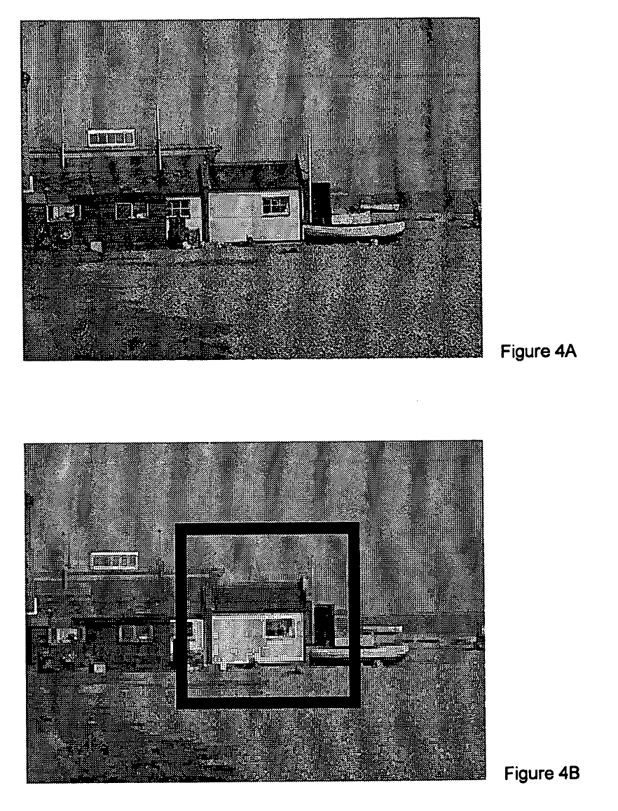

FIG. 4A shows an image to be processed in accordance with the invention;

FIG. 4B shows the image of FIG. 4A during a first stage of application of the present invention;

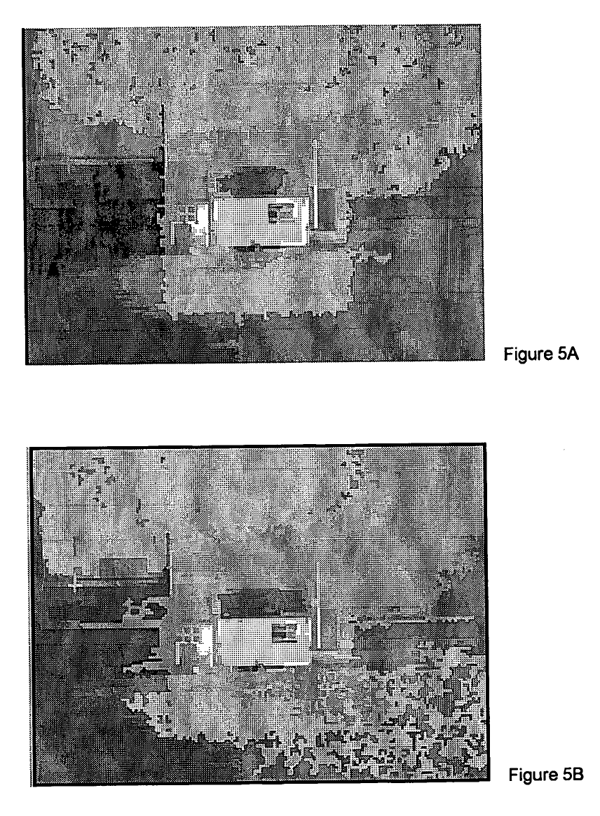

FIGS. 5A and 5B show images during a further stage of performance of the method of the invention;

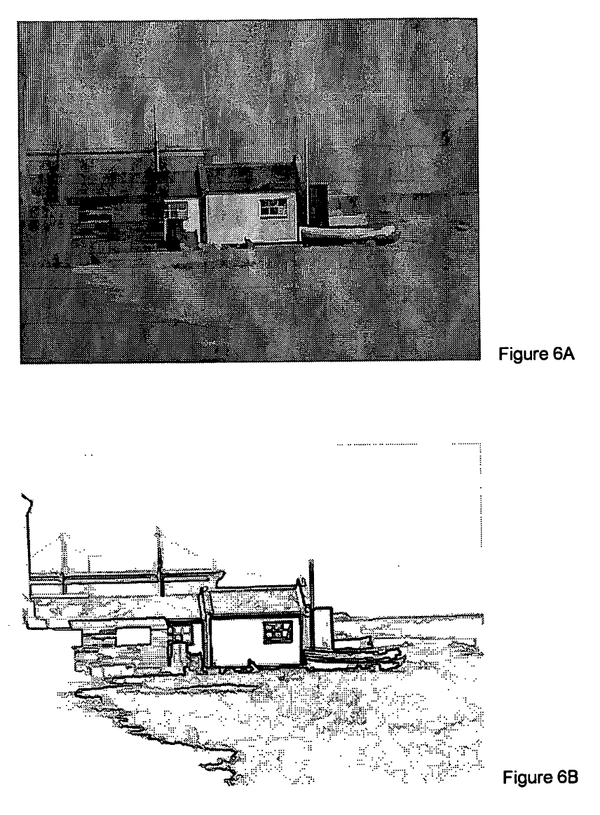

FIGS. 6A and 6B show images output following performance of the method of the present invention of the image of FIG. 4A;

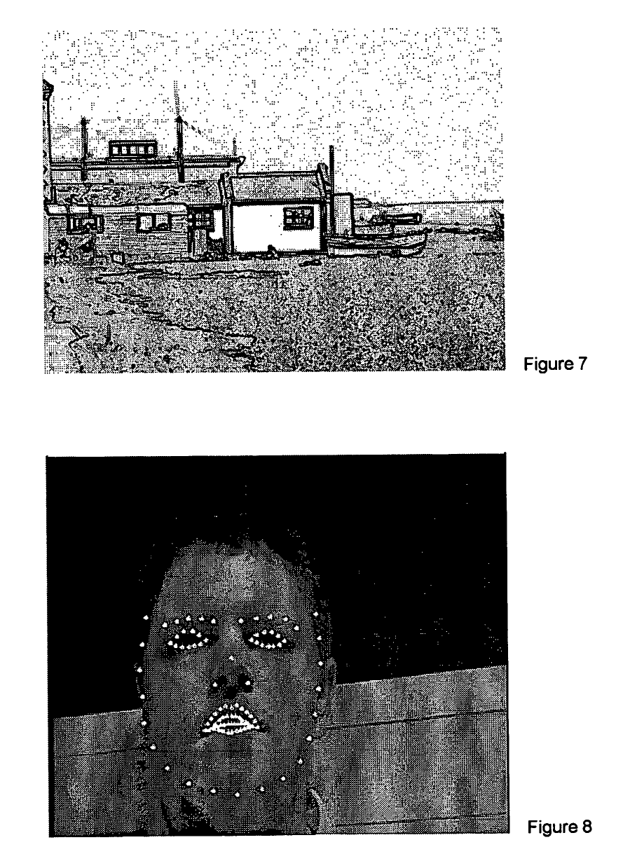

FIG. 7 shows the output of a standard edge detecting filter following input of the image of FIG. 4A thereto;

FIG. 8 shows an image on which an initial mask generation step is being performed;

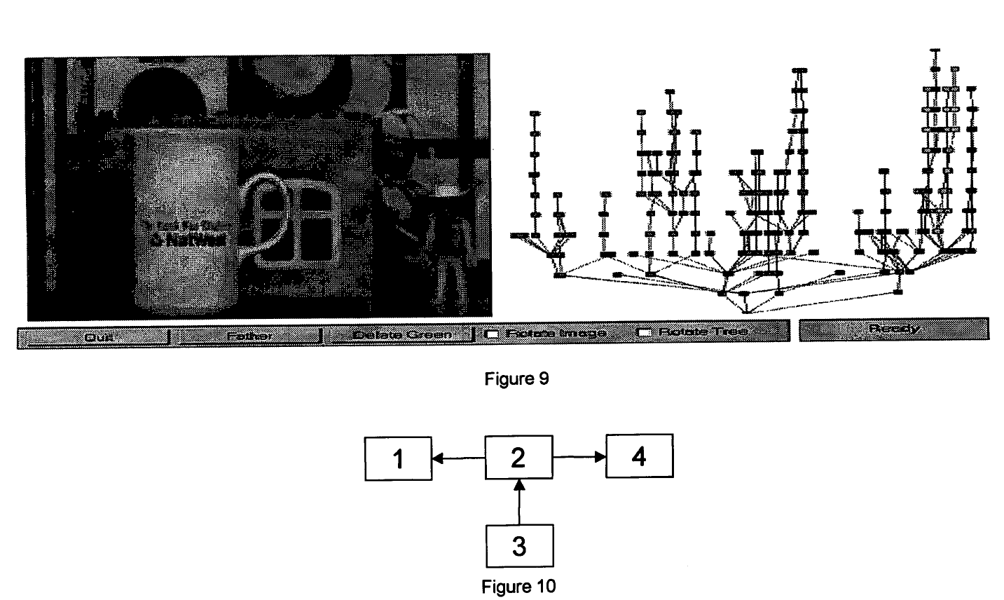

FIG. 9 shows an image and corresponding generated tree; and

FIG. 10 is a schematic diagram showing a system employing the invention.

FIGS. 1 and 2 show classic examples of representational art. FIG. 1 is a highly stylised image of a ship that is almost abstract in view of the artists choice to use extremely large and long brush strokes. FIG. 2 is a more realistic representation in which the artist has chosen to outline key features in the image that has been generated in order to, again, produce a pleasing effect.

FIGS. 3A to 3F show the output images resulting from a variety of different image processing algorithms applied to a single image. Each produces an interesting visual effect, but there are key distinctions between the images produced by such an automated process and by the process through which an artist travels to produce an artistic representation. In the images shown in FIGS. 1 and 2 there is a generally central region in which the artist has decided to introduce an increased level of detail when compared to its surrounding regions. The effect is subtle, but it results in a viewer being drawn to a particular region (for example the rear of the ship in FIG. 2). A skilful artist does this almost without thinking and by doing so produces a pleasing effect that, due to its subtlety, is not necessarily even noticed by a viewer. In the image processing effect shown in FIG. 3, however, the effects are applied in a uniform manner over the whole of the relevant figure. The image processing used to generate the images shown in FIG. 3 are generally edge removal and blurring effects, as well as luminance intensity variation effects. Whilst it is possible for such effects to produce visually pleasing end results, a viewer can readily ascertain that the effect is computer generated, and many viewers find the resulting image less visually appealing in view of this.

Images in FIGS. 3A to 3F have been processed using low pass sieves. Such sieves are becoming well established in the art in view of their ability to produce pleasing visual effects, and come in a variety of different forms. The use of such a sieve has benefits in the present invention that will be described later. However, an example of the present invention will now be described with reference to the example FIGS. 4 to 9.

FIG. 4A shows an original photograph on which the image processing method of the present invention is to be performed. The image can be pre-processed to produce a simplified image or an edge map image prior to performing the method of the invention but in this example the method is applied to the full un-processed image in FIG. 4A.

Once any base image pre-processing has been carried out an initial mask is automatically generated by a system employing the invention and the initial mask is placed either over the original image of FIG. 4A or one of the resultant pre-processed images described above. FIG. 4B shows a very simple square mask positioned centrally within the image.

A comparison is then carried out automatically of the edge of the region defined by the initial mask and any features which cross that edge in the image being processed. Accordingly, if the image of FIG. 4A is being processed and the mask is placed centrally, and is a square, then consideration will be given to the boundaries between the various levels of luminance and/or chrominance(in most cases the image being processed will be in colour) to find cross over points between the mask and such boundaries. Once the cross over points have been determined the system operates to find the regions in the image associated with such boundaries so as to provide a set of data which represents the boundary of a further processing region, which in this case will be generally central. The further processing region will no longer be the shape of the initial mask, but will have extended out beyond the boundaries of the initial mask in some places to incorporate the edges of a particular block of colour or feature of constant brightness or an object, and may have extended within the boundary of the initial mask in other areas so that in the end a region or processing mask is generated which is specific to the particular image being processed, yet which still has certain characteristics determined by the mask. An example of this is shown in FIG. 5A. The extent to which the shape of the initial mask is changed depends upon the characteristic that is used as a reference to which the initial mask edge is compared, as well as the reference value used for that comparison. FIG. 5B shows a reference mask which is considerably different to the original standard square mask of FIG. 4B.

This selected region is then adapted for further processing in either a manual or automated manner. In either case, the selected region may have additional colouring added to it or, in a simple and perhaps most easily understandable aspect, will have additional detail added to it by selecting the relevant detail from a pre-processed image. FIGS. 6A and 6B show resultant images. In FIG. 6A the original image of FIG. 4A has been passed through a sieve, the filtering level of which has been varied dependent upon whether the section of the original image of FIG. 4A is within the processing mask that has been generated or outside of that mask. As can be seen from FIG. 6A, the central section of the resultant image has a greater level of detail than the surrounding sections. FIG. 6B shows an alternative in which a standard edge detecting filter has been applied in combination with the processing mask, resulting, again, in a more detailed central region. For reference, FIG. 7 shows an image which is the result of passing the original reference image of FIG. 4A through a standard edge detecting filter, from which it can be seen that more detail has been removed from the peripheral regions of the regions of FIG. 6B. As will be appreciated the image that then results, whilst having undergone an automated process, gives the appearance of an image generated by a more skilled artist by having selected a particular region of the image for additional processing.

As will also be appreciated, more complex mask shapes may be provided. Indeed the masks shape may be generated dependent upon data provided by the image to be processed and may be based upon the level of detail determined in the image, such as the number of edges detected, or the relative luminance of various regions of the image. Of course, this data can be used to select an appropriate position for the mask as well as its shape.

As an alternative, the mask can be generated automatically based upon reference to statistical data generated from previously analysed images. For example, an analysis of all of the paintings of an artist such as Rembrandt will build up statistical data in relation to which areas that artist choose to add additional level of detail and, as such, the system employing the method of the present invention can be arranged to select corresponding areas on an image of choice.

Statistical analysis of the image may be employed to determine a region of interest, such as a face, through employment of standard face recognition models. This enables image processing of digital photographic portraits in such a way that sufficient level of detail is provided within the facial region of the subjects of the portrait to ensure that they are recognisable. FIG. 8 shows a mask generated in this manner and placed over the image from which it was generated.

Any statistical analysis may use a tree representation based upon colour or luminance or both for a particular image.

FIG. 9 shows more advanced image processing steps that may be employed in combination with the image processing described above and by using tree representations. In this case the tree shown in FIG. 9 generated from the shown image by company luminance levels. A tree with appropriate characteristics can then be selected to determine the location of the initial mask or, indeed, its location and shape. In this particular example the tree X with the highest luminance peak has been selected, with this tree corresponding generally to the location of the small doll at the right hand side of the image in FIG. 9. A mask could then be positioned over the doll to generate an initial mask which is simply the shape of the doll (once comparisons have been performed) or in the general region of the doll (again, once comparison has been performed) dependent upon the automated parameters which are used. Further processing of this image would then result in removal or blurring of the wording from the mug, for example, while retaining a high level of detail around the doll.

FIG. 10 shows a schematic block diagram of a system employing the invention which comprises a display 1, a central processor 2, an input 3, and a printer 4. The central processor 2 is appropriately configured to perform the method of the invention and provide information to a user via the display 1 either when the complete method has been performed or when, if desired, data is to be input by the user in order to customise the automated processing. The printer may be employed to provide a hard copy of a selected image.

1. A method of processing an image, the method comprising the steps of:
selecting an initial mask;
automatically comparing the initial mask with a selected characteristic of the image to generate data defining a processing mask within the image; and
processing the image within the processing mask to apply a visual effect to the image within the processing mask.

2. A method according to claim 1, wherein a visual effect is applied to the image outside of the processing mask.

3. A method according to claim 2, wherein the initial mask has a simple geometric shape such as a square or circle.

4. The method according to claim 1 or 2, wherein the initial mask has a shape which is determined by analysis of the image with respect to a predefined characteristic.

5. The method of claim 4, wherein the predefined characteristic is one or more of colour, luminance, color boundary, luminance boundary or image detail level.

6. A method of claim 4, wherein the shape of the initial mask is generated by employment of statistical data analysis generated from previously input images.

7. The method according to claim 5 or 6, wherein the initial mask is generated after the image has been processed by a simplification filter.

8. The method of any preceding claim wherein the initial mask is centred on the central region of the image.

9. The method of any preceding claim wherein the image processing that is performed on the generated region includes one or more of the addition of additional detail to the image in the generated region, change in the contrast of the image in the generated region, and a change in colouring of the image in the generated region.

10. The method of claim 4, wherein the initial mask is generated by employing a tree representation.

11. The method of claim 10, wherein nodes from the tree are selected by choosing the most likely features of the image to be a part of the focal region of interest by statistical analysis.

12. The method of claim 11, wherein the likelihood is established by reference to a previously obtained set of probabilities determined from a set of reference pictures or determined through user input.

13. The method of any preceding claim, wherein the selected image characteristic with which the initial mask is compared to generate the processing mask is at least one of colour boundary and luminance level.

14. A computer readable having instructions stored thereon to perform the steps of the method of any of the preceding claims.

15. An image processing system for processing an image,
a mask selector selecting an initial mask;
an automatic comparator for automatically comparing the initial mask with a selected characteristic of the image to generate data defining a processing mask within the image; and
a processor for processing the image within the processing mask to apply a visual effect to the image within the region of the processing mask.

16. A system according to claim 15, wherein the initial mask has a simple geometric shape such as a square or circle.

17. A system according to claim 15, wherein the initial mask has a shape which is determined by means for analysing the image with respect to a predefined characteristic.

18. The system of claim 17, wherein the predefined characteristic is one or more of: colour, luminance, color boundary, luminance boundary or image detail level.

19. The system of claim 17, wherein the shape of the initial mask is generated by processor employing statistical data analysis generated from previously input images.

20. A system according to claim 17, 18 or 19, wherein the initial mask is generated after the image has been pre-processed by a simplification filter.

21. The system of any preceding claim wherein the initial mask is centred on the central region of the image.

22. The system of any of claims 15 to 20, wherein the image processing that is performed on the region bonded by the processing mask includes one or more of the addition of additional detail to the image in the generated region, change in the contrast of the image in the region, and a change in colouring of the image in the region.

23. The system of claim 17, wherein the initial mask is generated by employing a tree representation.

24. The method of claim 23, wherein nodes from the tree are selected by choosing the most likely features of the image to be a part of the focal region of interest by statistical analysis.

25. The system of claim 24, wherein the likelihood is established by reference to a previously obtained set of probabilities determined from a set of reference pictures or determined through user input.

26. The system of any claims 15 to 25, wherein the selected image characteristic with which the initial mask is compared is at least one of colour boundary and luminance level boundary.
